(19) United States
(12) Patent Application Publication
(10) Pub. No.: US 2022/0212630 A1
(43) Pub. Date: Jul. 7, 2022

(54) INFORMATION PROCESSING DEVICE, VEHICLE CONTROL DEVICE, INFORMATION PROCESSING METHOD, AND PROGRAM

(71) Applicant: HONDA MOTOR CO., LTD., Minato-ku, Tokyo (JP)

(72) Inventor: Shigeru Namiki, Wako-shi (JP)

(21) Appl. No.: 17/611,918

(22) PCT Filed: May 24, 2019
(86) PCT No.: PCT/JP2019/020679

§ 371 Date: Nov. 17, 2021

(51) Int. Cl. B60R 25/30; B60R 25/31

(52) U.S. Cl. CPC B60R 25/305; B60L 58/12; B60R 25/302; B60R 25/31

(57) ABSTRACT

An information processing device includes an acquirer that acquires first data indicating a use situation of a target vehicle and second data indicating a use situation of a battery mounted in the target vehicle, and a determiner that, when the first data and the second data of a certain vehicle are input, inputs the first data and the second data acquired by the acquirer into a classifier learned to output third data indicating the presence or absence of unauthorized use of the certain vehicle and determines whether the target vehicle has been unauthorized used on the basis of the third data output by the classifier into which the first data and the second data are input.

### TECHNICAL FIELD

The present invention relates to an information processing device, a vehicle control device, an information processing method, and a program.

### BACKGROUND ART

A technique of deterring vehicle theft by, on condition that a hood that opens and closes a battery housing chamber is closed, capturing an image of the outside of the closed hood with an in-vehicle camera and transmitting the image captured by the in-vehicle camera to a database of a theft tracking service provider or the like is known (see, for example, Patent Literature 1).

### CITATION LIST

### Patent Literature

[Patent Literature 1]

Japanese Unexamined Patent Application, First Publication No. 2016-52847

### SUMMARY OF INVENTION

### Technical Problem

However, in the related art, unauthorized use of a vehicle such as theft cannot be accurately detected in some cases.

The present invention was contrived in view of such circumstances, and one object thereof is to provide an information processing device, a vehicle control device, an information processing method, and a program that make it possible to accurately detect unauthorized use of a vehicle.

### Solution to Problem

The following configurations are adopted in an information processing device, a vehicle control device, an information processing method, and a program according to the present invention.

(1) According to an aspect of the present invention, an information processing device is provided including: an acquirer that acquires first data indicating a use situation of a target vehicle and second data indicating a use situation of a battery mounted in the target vehicle; and a determiner that, when the first data and the second data of a certain vehicle are input, inputs the first data and the second data acquired by the acquirer into a classifier learned to output third data indicating the presence or absence of unauthorized use of the certain vehicle and determines whether the target vehicle has been unauthorized used on the basis of the third data output by the classifier into which the first data and the second data are input.

(2) The information processing device according to the aspect of the above (1) further includes: a communicator that communicates with a terminal device of an owner of the target vehicle; and a communication controller that, in a case where the determiner determines that the target vehicle has been unauthorized used, transmits first information prompting the owner to confirm the target vehicle to the terminal device through the communicator.

(3) The information processing device according to the aspect of the above (2) further includes a remote controller that remotely controls the target vehicle through the communicator in a case where the communicator does not receive second information which is a response to the first information from the terminal device after the first information is transmitted to the terminal device and before a predetermined time elapses.

(4) In the information processing device according to the aspect of the above (2) or (3), the acquirer further acquires biometric information of a user who uses the target vehicle, the information processing device further comprises an authenticator that authenticates that the user who uses the target vehicle is an owner of the target vehicle on the basis of the biometric information acquired by the acquirer, and the communication controller transmits the first information to the terminal device in a case where the authenticator does not authenticate that the user is the owner and the determiner determines that the target vehicle has been unauthorized used, and does not transmit the first information to the terminal device in a case where the authenticator authenticates that the user is the owner or a case where the determiner does not determine that the target vehicle has been unauthorized used.

(5) The information processing device according to the aspect of the above (1) further includes: a communicator that communicates with the target vehicle; and a remote controller that remotely controls the target vehicle through the communicator in a case where the determiner determines that the target vehicle has been unauthorized used.

(6) The information processing device according to any aspect of the above (1) to (5) further includes a learner that learns the classifier on the basis of the first data and the second data of an unauthorized used vehicle.

(7) According to another aspect of the present invention, a vehicle control device is provided including: at least one battery mounted in a target vehicle; a controller that causes the target vehicle to travel using electric power accumulated in the battery; an acquirer that acquires first data indicating a use situation of the target vehicle and second data indicating a use situation of the battery; and a determiner that, when the first data and the second data of a certain vehicle are input, inputs the first data and the second data acquired by the acquirer into a classifier learned to output third data indicating the presence or absence of unauthorized use of the certain vehicle and determines whether the target vehicle has been unauthorized used on the basis of the third data output by the classifier into which the first data and the second data are input.

(8) According to another aspect of the present invention, an information processing method is provided including causing a computer to: acquire first data indicating a use situation of a target vehicle and second data indicating a use situation of a battery mounted in the target vehicle; and when the first data and the second data of a certain vehicle are input, input the acquired first data and second data into a classifier learned to output third data indicating the presence or absence of unauthorized use of the certain vehicle and determine whether the target vehicle has been unauthorized used on the basis of the third data output by the classifier into which the first data and the second data are input.

(9) According to another aspect of the present invention, a program is provided for causing a computer to execute: a process of acquiring first data indicating a use situation of a target vehicle and second data indicating a use situation of a battery mounted in the target vehicle; and a process of, when the first data and the second data of a certain vehicle are input, inputting the acquired first data and second data into a classifier learned to output third data indicating the presence or absence of unauthorized use of the certain vehicle and determining whether the target vehicle has been unauthorized used on the basis of the third data output by the classifier into which the first data and the second data are input.

### Advantageous Effects of Invention

According to any aspect of (1) to (9), it is possible to accurately detect unauthorized use of a vehicle.

### BRIEF DESCRIPTION OF DRAWINGS

FIG. 1 is a diagram illustrating a configuration example of an unauthorized use detection system 1 including an information processing device and a vehicle control device according to a first embodiment.

FIG. 2 is a diagram illustrating an example of a configuration of a vehicle 10 according to the first embodiment.

FIG. 3 is a diagram illustrating an interior configuration of the vehicle 10 according to the first embodiment.

FIG. 4 is a diagram illustrating an example of a configuration of a center server 100 according to the first embodiment.

FIG. 5 is a flowchart illustrating a flow of a series of processes of runtime performed by a controller 120 in the first embodiment.

FIG. 6 is a diagram schematically illustrating a classifier MDL.

FIG. 7 is a flowchart illustrating a flow of a series of processes of training performed by the controller 120 in the first embodiment.

FIG. 8 is a diagram illustrating an example of a PCU 30X according to a second embodiment.

FIG. 9 is a diagram illustrating an example of hardware configurations of a PCU 30 and the center server 100 according to an embodiment.

### DESCRIPTION OF EMBODIMENTS

Hereinafter, embodiments of an information processing device, a vehicle control device, an information processing method, and a program of the present invention will be described with reference to the accompanying drawings. In the following description, a vehicle 10 is assumed to be an electric automobile, but the vehicle 10 is preferably a vehicle equipped with a secondary battery that supplies electric power for traveling, and may be a hybrid automobile or a vehicle equipped with a fuel cell.

### First Embodiment

[Overall Configuration]

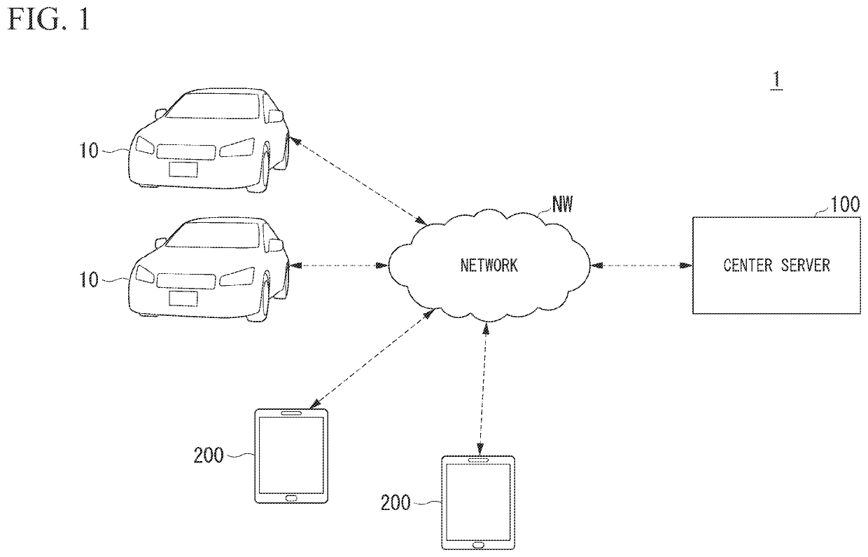

FIG. 1 is a diagram illustrating a configuration example of an unauthorized use detection system 1 including an information processing device and a vehicle control device according to a first embodiment. The unauthorized use detection system 1 is a system that detects that the vehicle 10 which is an electric automobile has been unauthorized used. Unauthorized use includes, for example, stealing the vehicle 10, removing a battery (which is hereinafter assumed to be synonymous with a secondary battery) from the vehicle 10, driving the vehicle 10 without an owner's permission, or the like.

As shown in FIG. 1, the unauthorized use detection system 1 includes a plurality of vehicles 10, a plurality of terminal devices 200, and a center server 100. The vehicle 10, the center server 100, and the terminal device 200 communicate with each other through a network NW. The network NW includes, for example, the Internet, a wide area network (WAN), a local area network (LAN), a provider device, a wireless base station, or the like.

The center server 100 detects that each of the plurality of vehicles 10 has been unauthorized used on the basis of information transmitted by each of the vehicles 10.

Each of the plurality of terminal devices 200 is a terminal device that can be used by an owner of each of the vehicles 10. Typically, the terminal device 200 is a mobile phone or a tablet terminal including a touch panel that also serves as a user interface and a display, a wireless communication interface having an antenna or the like, a storage, and an arithmetic unit such as a central processing unit (CPU).

In the terminal device 200, a user agent (UA) such as a web browser or an application program is started up. The terminal device 200 in which the UA is started up accepts various input operations from a user and performs various processes in accordance with the accepted input operations. The terminal device 200 may include devices such as a fingerprint sensor, a microphone, and a camera. In this case, the terminal device 200 may transmit biometric information such as an owner's fingerprint detected by a fingerprint sensor, the owner's voice collected by a microphone, or the owner's face image captured by a camera to the center server 100 through the network NW.

[Configuration of Vehicle]

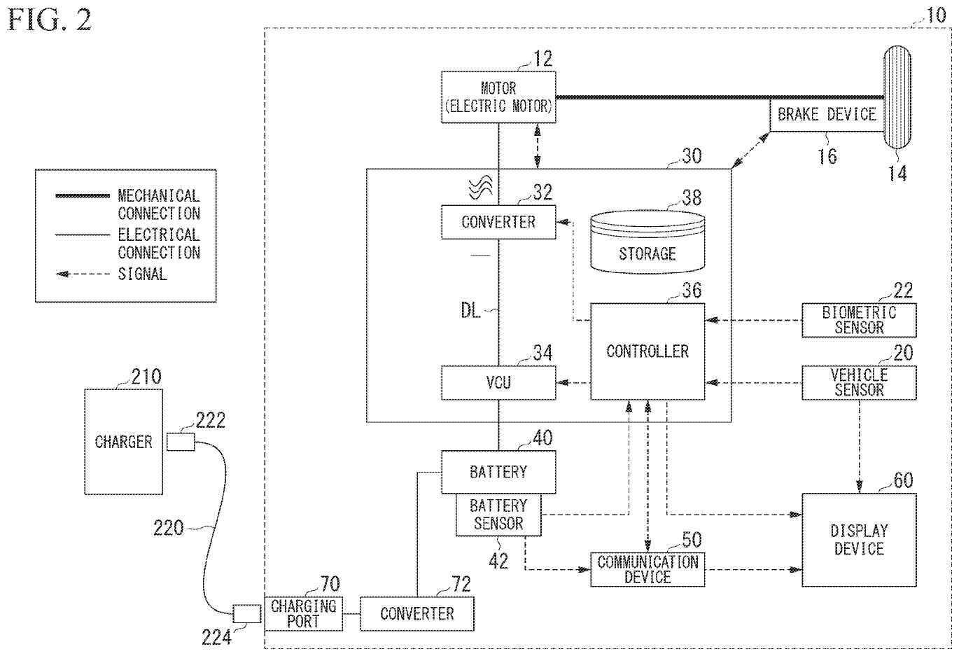

FIG. 2 is a diagram illustrating an example of a configuration of the vehicle 10 according to the first embodiment. As shown in FIG. 2, the vehicle 10 includes, for example, a motor 12, a driving wheel 14, a brake device 16, a vehicle sensor 20, a driving operation sensor 22, a biometric sensor 24, a power control unit (PCU) 30, a battery 40, a battery sensor 42, a communication device 50, a display device 60, a charging port 70, and a converter 72.

The motor 12 is, for example, a three-phase AC electric motor. The rotor of the motor 12 is connected to the driving wheel 14. The motor 12 outputs motive power to the driving wheel 14 using electric power to be supplied. The motor 12 generates power using kinetic energy of the vehicle during deceleration of the vehicle.

The brake device 16 includes, for example, a brake caliper, a cylinder that transfers hydraulic pressure to the brake caliper, and an electric motor that generates hydraulic pressure in the cylinder. The brake device 16 may include a mechanism that transfers hydraulic pressure generated by the operation of a brake pedal to the cylinder through a master cylinder as a backup. The brake device 16 is not limited to the above-described configuration and may be an electronic control hydraulic brake device that transfers hydraulic pressure of the master cylinder to the cylinder.

The vehicle sensor 20 includes, for example, an accelerator position sensor, a vehicle speed sensor, a brake stepping amount sensor, a steering sensor, a global navigation satellite system (GNSS) sensor, a yaw rate sensor, an orientation sensor, or the like.

The accelerator position sensor is attached to an accelerator pedal, and detects the amount of operation of the accelerator pedal. The accelerator position sensor outputs a signal indicating the detected amount of operation as an accelerator position to a controller 36.

The vehicle speed sensor includes, for example, a plurality of wheel speed sensors and a speed calculator. Each of the plurality of wheel speed sensors is attached to one wheel. The wheel speed sensor detects the speed or acceleration of the attached wheel. The speed calculator statistically calculates the speed or acceleration detected by the plurality of wheel speed sensors and calculates the speed or acceleration of the vehicle 10. The vehicle speed sensor outputs a signal indicating the calculated speed or acceleration of the vehicle 10 to the controller 36 and the display device 60.

The brake stepping amount sensor is attached to the brake pedal and detects the amount of operation of the brake pedal. The brake stepping amount sensor outputs a signal indicating the detected amount of operation as a brake stepping amount to the controller 36.

The steering sensor is attached to a steering wheel and detects the amount of operation of the steering wheel. For example, the steering sensor detects a weak electrical current generated by an occupant touching the steering wheel. The steering sensor may detect a steering torque generated around the rotating shaft (shaft) of the steering wheel. When the steering sensor detects a current or steering torque, it outputs a signal indicating the detection result to the controller 36.

The GNSS sensor receives a signal from a GNSS satellite such as a Global Positioning System (GPS) satellite, and detects the position of the vehicle 10 on the basis of the received signal. The GNSS sensor may correct the detected position of the vehicle 10 using an inertial navigation system (INS) that uses the output of the vehicle speed sensor, the yaw rate sensor, or the like. The GNSS sensor outputs a signal indicating the detected position of the vehicle 10 to the controller 36.

The yaw rate sensor detects the angular velocity of the vehicle 10 around its vertical axis. The yaw rate sensor outputs a signal indicating the detected angular velocity as a yaw rate to the controller 36.

The orientation sensor detects the direction of the vehicle 10. The orientation sensor outputs a signal indicating the detected direction as an orientation to the controller 36.

The biometric sensor 24 detects biometric information of a driver of the vehicle 10. For example, the biometric sensor 24 detects information such as a fingerprint, palm print, iris, vein, face image, or voice of the driver. In the case where a fingerprint or a palm print is detected, the biometric sensor 24 may be provided on the steering wheel. The biometric sensor 24 outputs the detected biometric information to the controller 36.

The PCU 30 includes, for example, a converter 32, a voltage control unit (VCU) 34, the controller 36, and a storage 38. In the shown example, these components are configured as one unit as the PCU 30, but the present invention is not limited to this, and a plurality of components may be disposed in a distributed manner.

The converter 32 is, for example, an AC-DC converter. The direct-current side terminal of the converter 32 is connected to a direct-current link DL. The battery 40 is connected to the direct-current link DL through the VCU 34. The converter 32 converts an alternating current generated by the motor 12 into a direct current and outputs the converted current to the direct-current link DL.

The VCU 34 is, for example, a DC-DC converter. The VCU 34 boosts electric power which is supplied from the battery 40 and outputs the boosted electric power to the direct-current link DL.

The controller 36 includes, for example, a motor controller 36A, a brake controller 36B, a battery/VCU controller 36C, and a communication controller 36D. The motor controller 36A, the brake controller 36B, the battery/VCU controller 36C, and the communication controller 36D may be replaced with separate control devices. The separate control devices are, for example, a motor electronic control unit (ECU), a brake ECU, and a battery ECU.

Some or all of the components of the controller 36 are realized by a processor such as, for example, a central processing unit (CPU) or a graphics processing unit (GPU) executing a program (software). In addition, some or all of these components may be realized by hardware (circuit unit; including circuitry) such as a large scale integration (LSI), an application specific integrated circuit (ASIC), or a field-programmable gate array (FPGA) and may be realized by software and hardware in cooperation. The program may be stored in an HDD, a flash memory, or the like of the storage 38 in advance or may be stored in a detachable storage medium such as a DVD or a CD-ROM and be installed in the storage 38 by the storage medium being mounted in a drive device.

The motor controller 36A controls the motor 12 on the basis of the output of the vehicle sensor 20. The brake controller 36B controls the brake device 16 on the basis of the output of the vehicle sensor 20.

The battery/VCU controller 36C calculates the state of charge (SOC) of the battery 40 on the basis of the output of the battery sensor 42 attached to the battery 40. In the case where the calculated SOC of the battery 40 is equal to or higher than a threshold, the battery/VCU controller 36C instructs the VCU 34 to increase the voltage of the direct-current link DL.

The communication controller 36D controls the communication device 50 and transmits data indicating a feature of behavior of the vehicle 10 under manual driving (hereinafter referred to as vehicle feature data), data indicating a feature of operation of the battery 40 used under manual driving (hereinafter referred to as battery feature data), and biometric information detected by the biometric sensor 24 to the center server 100 through the network NW.

The vehicle feature data includes information such as, for example, the detection result of the vehicle sensor 20, a vehicle ID for identifying the vehicle 10, the vehicle model of the vehicle 10, the size of the vehicle 10, position information of the vehicle 10, and the time. The battery feature data includes information such as, for example, the SOC of the battery 40 calculated by the battery/VCU controller 36C, the detection result of the battery sensor 42, a battery ID for identifying the battery 40, the capacity of the battery 40, the nominal voltage of the battery 40, the type of battery 40, and the time.

The storage 38 is realized by, for example, an HDD, a flash memory, electrically erasable programmable read only memory (EEPROM), read only memory (ROM), random access memory (RAM), or the like. The storage 38 stores, for example, a program or the like which is read out and executed by a processor.

The battery 40 is a secondary battery such as, for example, a lithium-ion battery. The battery 40 accumulates electric power introduced from a charger 210 outside of the vehicle 10 and discharges electric power accumulated for traveling of the vehicle 10.

The battery sensor 42 includes, for example, a current sensor, a voltage sensor, and a temperature sensor. The battery sensor 42 detects, for example, the current value, voltage value, and temperature of the battery 40. The battery sensor 42 outputs the detected current value, voltage value, temperature, and the like to the controller 36.

The communication device 50 includes a wireless module for connection to the network NW. The communication device 50 transmits various types of information such as the vehicle feature data or the battery feature data to the center server 100 in accordance with an instruction of the controller 36. The communication device 50 receives information from the center server 100 through the network NW. The communication device 50 outputs the received information to the controller 36 or the display device 60.

The display device 60 includes a first display 60A and a second display 60B.

The first display 60A and the second display 60B are, for example, liquid crystal displays (LCDs), organic electro luminescence (EL) display devices, or the like. The first display 60A and the second display 60B display information output by the controller 36 or information received from the center server 100 by the communication device 50.

The charging port 70 is provided toward the outside of the body of the vehicle 10. The charging port 70 is connected to the charger 210 through a charging cable 220. The charging cable 220 includes a first plug 222 and a second plug 224. The first plug 222 is connected to the charger 210, and the second plug 224 is connected to the charging port 70. Electricity supplied from the charger 210 is supplied to the charging port 70 through the charging cable 220.

In addition, the charging cable 220 includes a signal cable attached to a power cable. The signal cable mediates communication between the vehicle 10 and the charger 210. Therefore, each of the first plug 222 and the second plug 224 is provided with a power connector and a signal connector.

The converter 72 is provided between the charging port 70 and the battery 40. The converter 72 converts a current introduced from the charger 210 through the charging port 70, for example, an alternating current into a direct current. The converter 72 outputs the converted direct current to the battery 40.

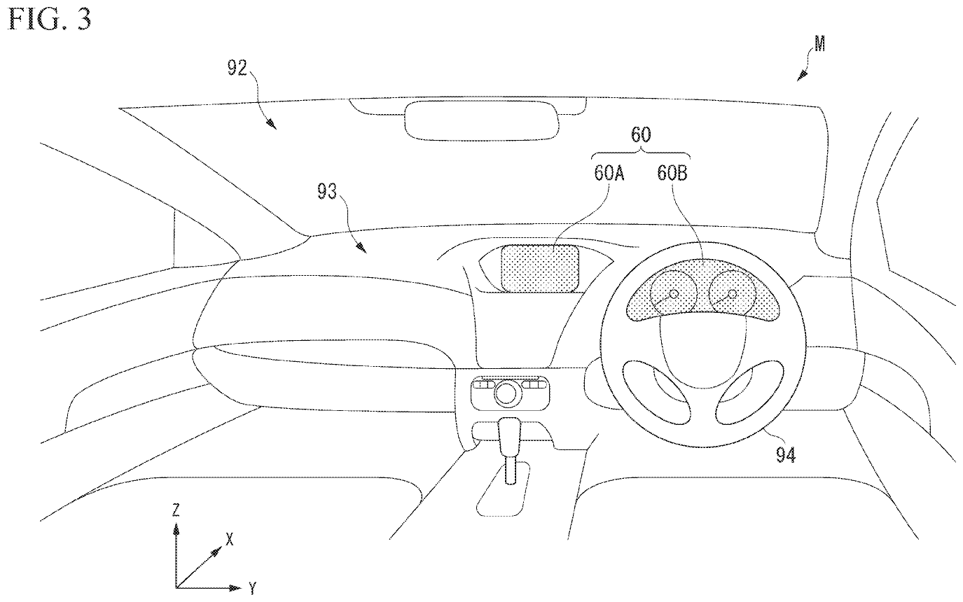

FIG. 3 is a diagram illustrating an interior configuration of the vehicle 10 according to the first embodiment. As shown in FIG. 3, the vehicle 10 is provided with, for example, a steering wheel 91, a front windshield 92, and an instrument panel 93. The front windshield 92 is a light-transmissive member.

The first display 60A is provided in the vicinity of the front of a driver's seat (a seat closest to the steering wheel 91) in the instrument panel 93 and is installed at a position that can be visually recognized by an occupant from a gap in the steering wheel 91 or over the steering wheel 91.

The second display 60B is installed, for example, at the center of the instrument panel 93. The second display 60B, for example, displays a navigation result of a navigation device (not shown) as an image, displays a television program, plays a DVD, or displays content such as a downloaded movie.

[Configuration of Center Server]

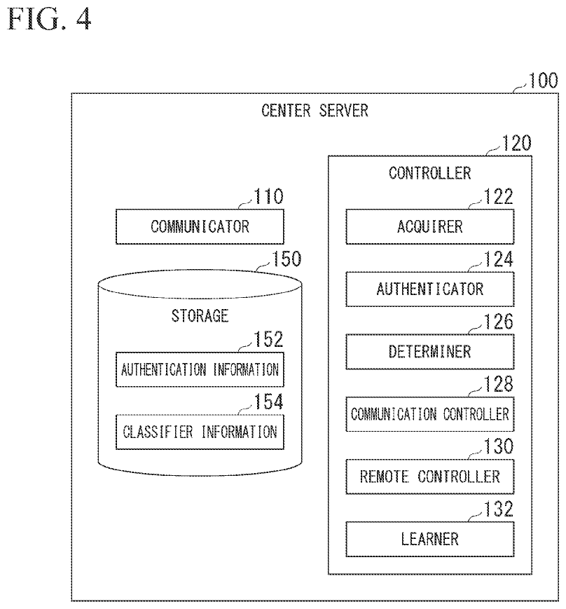

FIG. 4 is a diagram illustrating an example of a configuration of the center server 100 according to the first embodiment. As shown in FIG. 4, the center server 100 includes, for example, a communicator 110, a controller 120, and a storage 150.

The communicator 110 includes a communication interface such as, for example, an antenna or a network interface card (NIC). The communicator 110 communicates with each of the plurality of vehicles 10 through the network NW. For example, the communicator 110 receives the vehicle feature data and the battery feature data from each of the vehicles 10.

The controller 120 includes, for example, an acquirer 122, an authenticator 124, a determiner 126, a communication controller 128, a remote controller 130, and a learner 132. Processing of each of these components will be described later.

Some or all of these components of the controller 120 are realized by a processor such as, for example, a CPU or a GPU executing a program (software). In addition, some or all of these components may be realized by hardware (a circuit unit;

including circuitry) such as an LSI, an ASIC, or an FPGA, or may be realized by software and hardware in cooperation.

The program may be stored in the HDD, flash memory, or the like of the storage 150 in advance, may be stored in a detachable storage medium such as a DVD or a CD-ROM or may be installed in the storage 150 by the storage medium being mounted in a drive device.

The storage 150 is realized by, for example, an HDD, a flash memory, an EEPROM, a ROM, a RAM, or the like. The storage 150 stores, for example, authentication information 152, classifier information 154, or the like in addition to a program which is read out and executed by a processor.

The authentication information 152 is, for example, a database in which biometric information of a user (such as, for example, an owner of the vehicle 10) determined in advance is registered with respect to a vehicle ID of each of the vehicles 10.

The classifier information 154 is information (a program or data structure) that defines a classifier MDL for performing pattern classification as to whether the vehicle 10 is being unauthorized used or not being unauthorized used. The details of the classifier MDL will be described later.

[Process Flow at Runtime]

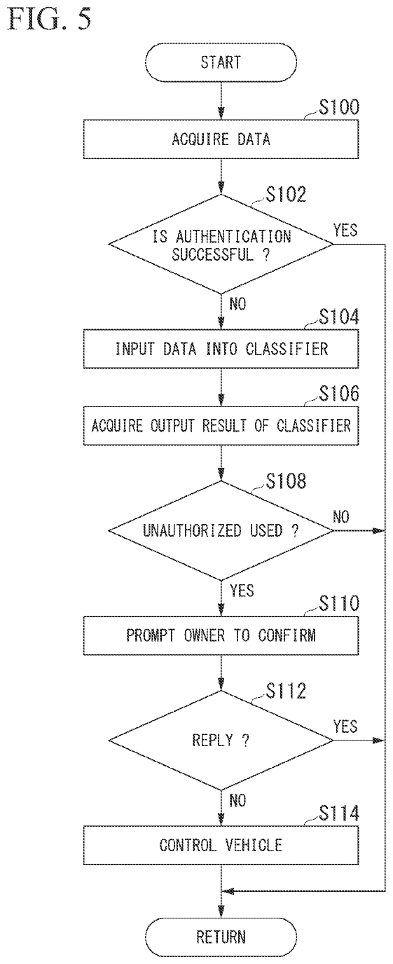

Hereinafter, a flow of a series of processes of the controller 120 at runtime will be described with reference to a flowchart. The term “runtime” refers to a time at which various processes are executed using the already learned classifier MDL. FIG. 5 is a flowchart illustrating a flow of a series of processes of runtime performed by the controller 120 in the first embodiment. The processing of the present flowchart may be repeatedly performed, for example, at a predetermined cycle.

First, the acquirer 122 acquires the vehicle feature data, the battery feature data, and the biometric information from the vehicle 10 through the communicator 110 (step S100). The acquirer 122 may acquire the biometric information from the terminal device 200 owned by the owner of the vehicle 10 or the like instead of acquiring the biometric information from the vehicle 10. In the following description, the vehicle 10 that has transmitted at least the vehicle feature data and the battery feature data to the center server 100 is referred to as a target vehicle 10T.

Next, the authenticator 124 determines whether the biometric authentication of a driver of the target vehicle 10T is successful on the basis of the biometric information acquired by the acquirer 122 and the authentication information 152 (step S102).

For example, the authenticator 124 determines whether the biometric information acquired by the acquirer 122 and biometric information included in the authentication information 152 coincide with each other. In a case where the biometric information acquired by the acquirer 122 and the biometric information included in the authentication information 152 coincide with each other, the authenticator 124 determines that the biometric authentication of the driver of the target vehicle 10T is successful.

On the other hand, in a case where the biometric information acquired by the acquirer 122 and the biometric information included in the authentication information 152 do not coincide with each other, or a case where the biometric information is not acquired by the acquirer 122, the authenticator 124 determines that the biometric authentication of the driver of the target vehicle 10T has failed.

In a case where the biometric authentication of the driver of the target vehicle 10T is successful, the controller 120 ends the processing of the present flowchart.

On the other hand, in a case where the biometric authentication of the driver of the target vehicle 10T has failed, the determiner 126 inputs the vehicle feature data and the battery feature data acquired by the acquirer 122 into the classifier MDL indicated by the classifier information 154 (step S104).

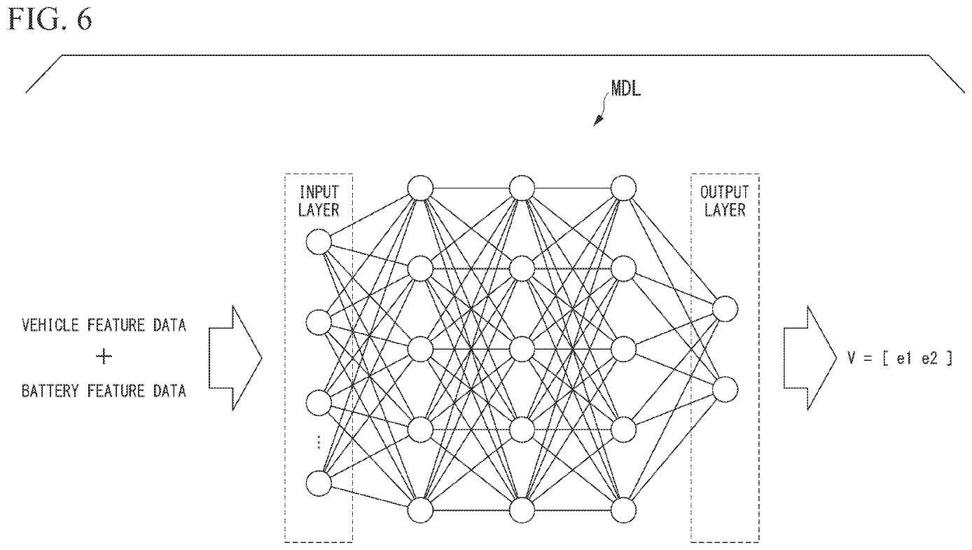

FIG. 6 is a diagram schematically illustrating the classifier MDL. As in the shown example, the classifier MDL may be realized using a deep neural network. The classifier MDL is not limited to a deep neural network, and may be realized by other models such as logistic regression, Support Vector Machine (SVM), k-Nearest Neighbor algorithm (k-NN), decision tree, Naïve Bayes classifier, or Random Forest.

In a case where the classifier MDL is realized by a deep neural network, the deep neural network may be, for example, a convolutional neural network or a recurrent neural network.

In a case where the classifier MDL is a deep neural network, the classifier information 154 includes various types of information such as, for example, connection information on how neurons (units) included in an input layer, one or more hidden layers (intermediate layers), and an output layer that constitute each neural network are connected to each other, or connection coefficients imparted to data which is input and output between connected neurons.

The connection information includes, for example, the number of neurons included in each layer, information for designating the type of neuron to which each neuron is connected, an activation function of realizing each neuron, and information such as a gate provided between neurons in the hidden layer.

The activation function of realizing neurons may be, for example, a rectified linear unit function (ReLU function), a sigmoid function, a step function, other functions, or the like.

The gate selectively passes or weights data transferred between neurons, for example, in accordance with a value (for example, 1 or 0) returned by the activation function.

The connection coefficient is a parameter of the activation function and includes a weight imparted to output data when data is output from a neuron in a certain layer to a neuron in a deeper layer, for example, in a hidden layer of a neural network. In addition, the connection coefficient may include a bias component or the like peculiar to each layer.

For example, when the vehicle feature data and the battery feature data as described above are input, the classifier MDL outputs a probability indicating the likelihood of the target vehicle 10T having been unauthorized used. Specifically, in a case where a probability indicating that the target vehicle 10T is unauthorized used is P1, a probability indicating that the target vehicle 10T is not unauthorized used is P2, and the sum of P1 and P2 is 1, the classifier MDL outputs a vector V (=[e1, e2]) in which the probability P1 is included as an element e1 and the probability P2 is included as an element e2. The vector V is an example of “third data.”

The flowchart of FIG. 5 will be described again. Next, the determiner 126 acquires the classification result (vector V) from the classifier MDL into which the vehicle feature data and the battery feature data of the target vehicle 10T are input (step S106).

Next, the determiner 126 determines whether the target vehicle 10T has been unauthorized used on the basis of the classification result of the classifier MDL (step S108).

For example, when the vector V indicating the probability of unauthorized use is output by the classifier MDL, the determiner 126 determines whether unauthorized use has occurred on the basis of the value of each element included in the vector V. Specifically, in a case where the value of the element e1, that is, the probability P1, is equal to or greater than a threshold, the determiner 126 determines that the target vehicle 10T has been unauthorized used.

In a case where the determiner 126 determines that the target vehicle 10T has been unauthorized used, the communication controller 128 transmits confirmation information to the terminal device 200 owned by the owner of the target vehicle 10T through the communicator 110 (step S110). The confirmation information is information for prompting the owner of the target vehicle 10T to confirm whether the target vehicle 10T has been unauthorized used. The confirmation information is an example of “first information.”

Next, the remote controller 130 determines whether the communicator 110 has received reply information from the terminal device 200 to which the confirmation information has been transmitted after the confirmation information is transmitted to the terminal device 200 owned by the owner of the target vehicle 10T and before a predetermined time (for example, an hour) elapses (step S112). The reply information is information indicating that the owner of the target vehicle 10T has made some kind of reply (for example, a reply that the target vehicle 10T has not been unauthorized used) to the confirmation information. The reply information is an example of “second information.”

For example, in a case where the communicator 110 does not receive the reply information before a predetermined time elapses, the remote controller 130 remotely controls the target vehicle 10T by transmitting a control command to the target vehicle 10T through the communicator 110 (step S114). This concludes the processing of the present flowchart.

For example, the remote controller 130 transmits a stop command for stopping the target vehicle 10T or a function restriction command for restricting some functions of the target vehicle 10T to the target vehicle 10T.

For example, in a case where the stop command is received by the communication device 50, the controller 36 of the target vehicle 10T controls the motor 12, the brake device 16, the converter 32, the VCU 34, or the like to decelerate and stop the target vehicle 10T.

In addition, for example, in a case where the function restriction command is received by the communication device 50, the controller 36 of the target vehicle 10T restricts displaying various types of information on the display device 60 or controls the converter 72 to restrict charging the battery 40 with electric power supplied from the charging port 70.

[Process Flow of Training]

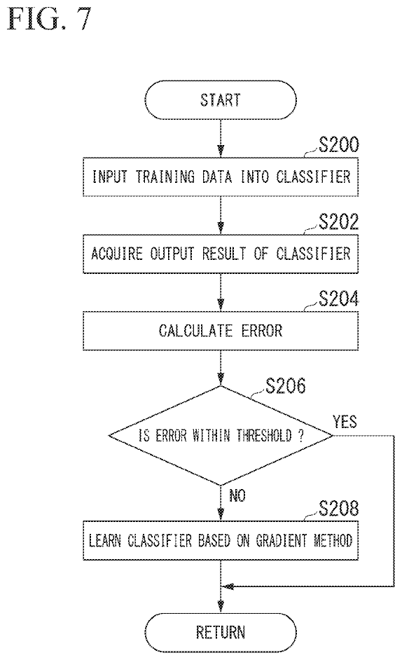

Next, a flow of a series of processes of the controller 120 during training will be described with reference to a flowchart. The term “training” refers to the time to train the classifier MDL used at runtime. FIG. 7 is a flowchart illustrating a flow of a series of processes of training performed by the controller 120 in the first embodiment. The processing of the present flowchart may be repeatedly performed, for example, at a predetermined cycle.

First, the learner 132 inputs training data into the classifier MDL in order to train the classifier MDL (step S200). The training data is, for example, data in which, when an owner's consent is obtained and then the owner is not using the vehicle 10, information of the vehicle having been unauthorized used is associated with vehicle feature data and battery feature data obtained when a third party drives the vehicle 10, that is, vehicle feature data and battery feature data obtained under the same situation as unauthorized use such as theft, as a training level. The training level may be, for example, a vector V in which e1 is 1 and e2 is 0.

Next, the learner 132 acquires the vector V which is a classification result from the classifier MDL into which the training data is input (step S202).

Next, the learner 132 calculates an error between the vector V acquired from the classifier MDL and the vector V associated with the vehicle feature data and the battery feature data as a training level (step S204).

Next, the learner 132 determines whether the calculated error is within a threshold (step S206), and learns parameters of the classifier MDL on the basis of a gradient method such as reverse error propagation in a case where the error exceeds the threshold (step S208). The parameters are, for example, a weight coefficient, a bias component, or the like. This concludes the processing of the present flowchart.

By learn the classifier MDL in this way, for example, in a case where a third party other than the owner drives the vehicle 10, the driving is determined to be unauthorized. For example, in a case where the owner is a user who frequently steps on the accelerator pedal, a large amount of current is supplied from the battery 40 to the motor 12. On the other hand, in a case where a third party steps on the accelerator pedal less often or less than the owner per unit time, the current supplied from the battery 40 to the motor 12 tends to be smaller than when the owner drives. Therefore, by learning the classifier MDL in advance using characteristic data in which such driving habits, individual differences, and the like are clearly reflected, it is possible to detect unauthorized use without monitoring with a camera or requiring biometric authentication.

According to the first embodiment described above, the center server 100 acquires vehicle feature data indicating the feature of behavior when the target vehicle 10T is used and battery feature data indicating the feature of operation of the battery 40 mounted in the target vehicle 10T, inputs the acquired vehicle feature data and battery feature data into the classifier MDL learned in advance, and determines whether the target vehicle 10T has been unauthorized used on the basis of the output result of the classifier MDL into which these pieces of data are input, whereby it is possible to accurately detect the unauthorized use of the vehicle.

In addition, according to the above-described first embodiment, the owner of a vehicle that has been unauthorized used (or has a high probability of being unauthorized used) is caused to confirm his/her own vehicle or remotely control the vehicle, and thus it is possible to more effectively prevent the vehicle from being unauthorized used.

### Second Embodiment

Hereinafter, a second embodiment will be described. In the above-described first embodiment, a case where the center server 100 determines the unauthorized use of the vehicle 10 has been described. On the other hand, the second embodiment is different from the above-described first embodiment in that the controller 36 of the PCU 30 determines the unauthorized use of a vehicle 10 in which the PCU is mounted (hereinafter referred to as a host vehicle 10S). Hereinafter, a description will be given with focus on differences from the first embodiment, and common functions and the like with respect to those in the first embodiment will not be described.

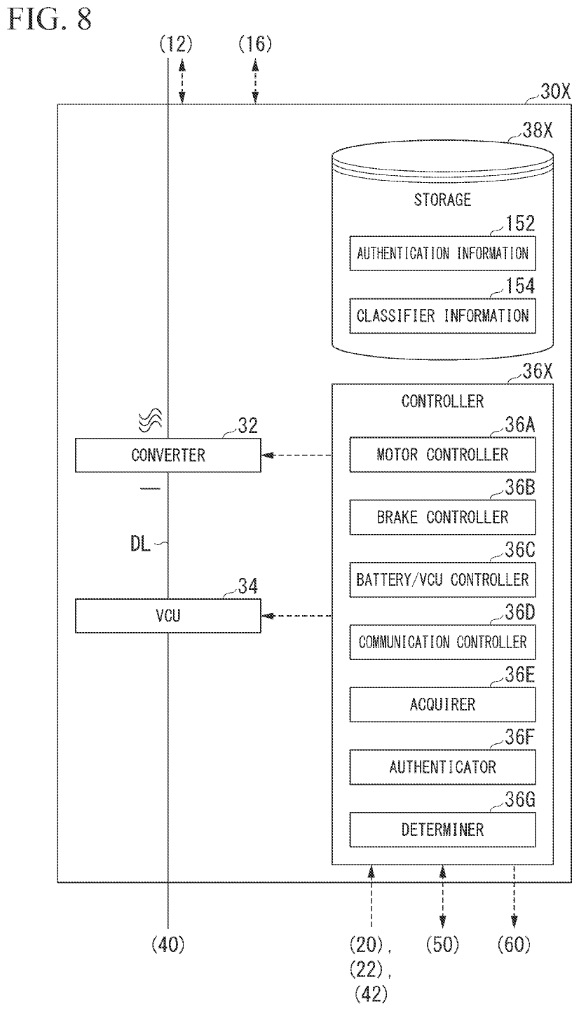

FIG. 8 is a diagram illustrating an example of a PCU 30X according to the second embodiment. A controller 36X of the PCU 30X according to the second embodiment further includes an acquirer 36E, an authenticator 36F, and a determiner 36G in addition to the motor controller 36A, the brake controller 36B, the battery/VCU controller 36C, and the communication controller 36D which are described above.

A storage 38X of the PCU 30X according to the second embodiment stores the authentication information 152 and the classifier information 154 described above in addition to a program which is read out and executed by a processor. For example, as for the classifier information 154, when the classifier MDL is learned by the center server 100, information of the learned classifier MDL is installed in the storage 38X as the classifier information 154.

The acquirer 36E acquires various detection results such as accelerator position, vehicle speed, the amount of brake stepping, the amount of operation of a steering wheel, position information, yaw rate, or orientation, as the vehicle feature data, from the vehicle sensor 20. In addition, the acquirer 36E acquires the calculation result of SOC as the battery feature data from the battery/VCU controller 36C, or acquires detection results such as the current value, voltage value, and temperature of the battery 40 as the battery feature data from the battery sensor 42.

When the biometric information is acquired by the acquirer 36E, the authenticator 36F determines whether the biometric authentication of the driver of the host vehicle 10S is successful on the basis of the biometric information and the authentication information 152.

The determiner 36G inputs the vehicle feature data and the battery feature data of the host vehicle 10S acquired by the acquirer 36E into the classifier MDL indicated by the classifier information 154. The determiner 36G determines whether the host vehicle 10S has been unauthorized used on the basis of the classification result of the classifier MDL into which the vehicle feature data and the battery feature data of the host vehicle 10S are input.

In a case where the determiner 36G determines that the host vehicle 10S has been unauthorized used, the communication controller 36D transmits the confirmation information to the terminal device 200 owned by the owner of the host vehicle 10S through the communication device 50.

In addition, in a case where the determiner 36G determines that the host vehicle 10S has been unauthorized use, the motor controller 36A may control the motor 12, the brake controller 36B may control the brake device 16, and the battery/VCU controller 36C may control the VCU 34 to thereby stop the host vehicle 10S.

According to the second embodiment described above, the PCU 30X acquires vehicle feature data indicating the feature of behavior when the host vehicle 10S is used and battery feature data indicating the feature of operation of the battery 40 mounted in the host vehicle 10S, inputs the acquired vehicle feature data and battery feature data into the classifier MDL learned in advance, and determines whether the host vehicle 10S has been unauthorized used on the basis of the output result of the classifier MDL into which these pieces of data are input. As a result, similarly to the above-described first embodiment, it is possible to accurately detect unauthorized use of a vehicle.

[Hardware Configuration]

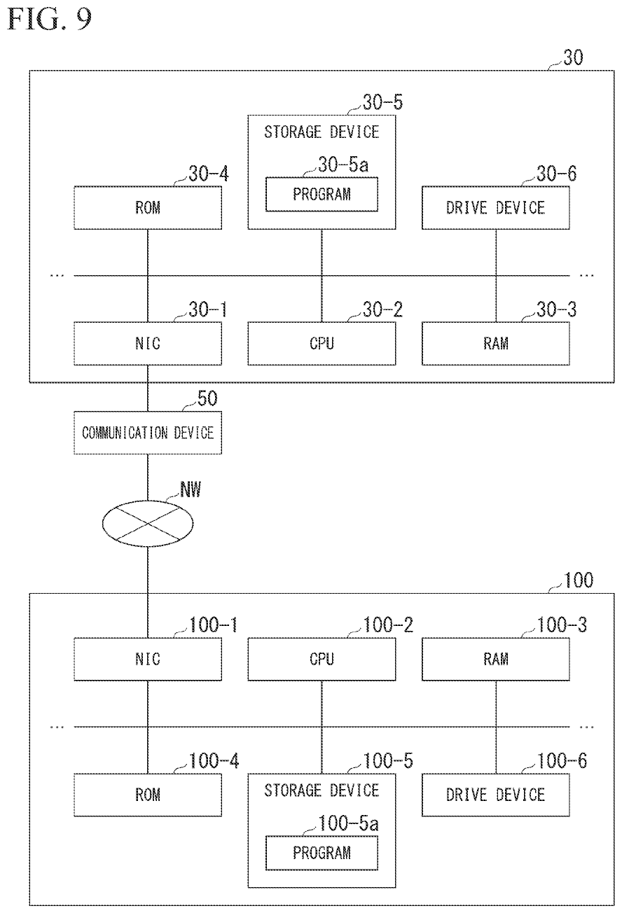

FIG. 9 is a diagram illustrating an example of hardware configurations of the PCU 30 and the center server 100 according to an embodiment.

As shown in the drawing, the PCU 30 is configured such that a communication controller 30-1, a CPU 30-2, a RAM 30-3 used as a working memory, a ROM 30-4 that stores a boot program or the like, a storage device 30-5 such as a flash memory or an HDD, a drive device 30-6, and the like are connected to each other through an internal bus or a dedicated communication line. The communication controller 30-1 communicates with other devices mounted in the vehicle 10. The storage device 30-5 stores a program 30-5a executed by the CPU 30-2. This program 30-5a is developed into the RAM 30-3 by a direct memory access (DMA) controller (not shown) or the like, and is executed by the CPU 30-2. Thereby, the controller 36 is realized.

The center server 100 is configured such that a communication controller 100-1, a CPU 100-2, a RAM 100-3 used as a working memory, a ROM 100-4 that stores a boot program or the like, a storage device 100-5 such as a flash memory or an HDD, a drive device 100-6, and the like are connected to each other through an internal bus or a dedicated communication line. The communication controller 100-1 communicates with the communication device 50 mounted in the vehicle 10 or the terminal device 200. The storage device 100-5 stores a program 100-5a executed by the CPU 100-2. This program 100-5a is developed into the RAM 100-3 by a DMA controller (not shown) or the like, and is executed by the CPU 100-2. Thereby, the controller 120 is realized.

The above-described embodiment can be represented as follows.

An information processing device including:

at least one memory having at least one program stored therein; and

at least one processor,

wherein the processor executes the program, to thereby

acquire first data indicating a use situation of a target vehicle and second data indicating a use situation of a battery mounted in the target vehicle, and

when the first data and the second data of a certain vehicle are input, input the acquired first data and second data into a classifier learned to output third data indicating the presence or absence of unauthorized use of the certain vehicle and determine whether the target vehicle has been unauthorized used on the basis of the third data output by the classifier into which the first data and the second data are input.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

### REFERENCE SIGNS LIST

1 Unauthorized use detection system
10 Vehicle
12 Motor
14 Driving wheel
16 Brake device
20 Vehicle sensor
22 Driving operation sensor
24 Biometric sensor
30 PCU
32 Converter
34 VCU
36 Controller
38 Storage
40 Battery
42 Battery sensor
50 Communication device
60 Display device
70 Charging port
72 Converter
100 Center server
110 Communicator
120 Controller
122 Acquirer
124 Authenticator
126 Determiner
128 Communication controller
130 Remote controller
132 Learner
150 Storage
200 Terminal device

What is claim is:

1.-9. (canceled)

10. An information processing device comprising:
a communicator that communicates with a target vehicle;
an acquirer that acquires first data indicating a use situation of the target vehicle and second data indicating a use situation of a battery mounted in the target vehicle through the communicator;
a determiner that, when the first data and the second data of a certain vehicle are input, inputs the first data and the second data acquired by the acquirer into a classifier learned to output third data indicating the presence or absence of unauthorized use of the certain vehicle and determines whether the target vehicle has been unauthorized used on the basis of the third data output by the classifier into which the first data and the second data are input; and
a remote controller that remotely controls the target vehicle through the communicator in a case where the determiner determines that the target vehicle has been unauthorized used.

11. The information processing device according to claim 10, further comprising:
a communicator that communicates with a terminal device of an owner of the target vehicle; and
a communication controller that, in a case where the determiner determines that the target vehicle has been unauthorized used, transmits first information prompting the owner to confirm the target vehicle to the terminal device through the communicator.

12. The information processing device according to claim 11, further comprising:
a remote controller that remotely controls the target vehicle through the communicator in a case where the communicator does not receive second information which is a response to the first information from the terminal device after the first information is transmitted to the terminal device and before a predetermined time elapses.

13. The information processing device according to claim 11, wherein
the acquirer further acquires biometric information of a user who uses the target vehicle, the information processing device further comprises an authenticator that authenticates that the user who uses the target vehicle is an owner of the target vehicle on the basis of the biometric information acquired by the acquirer, and
the communication controller:
transmits the first information to the terminal device in a case where the authenticator does not authenticate that the user is the owner and the determiner determines that the target vehicle has been unauthorized used, and
does not transmit the first information to the terminal device in a case where the authenticator authenticates that the user is the owner or a case where the determiner does not determine that the target vehicle has been unauthorized used.

14. The information processing device according to claim 10, further comprising:
a learner that learns the classifier on the basis of the first data and the second data of an unauthorized used vehicle.

15. A vehicle control device comprising:
at least one battery mounted in a target vehicle;
a controller that causes the target vehicle to travel using electric power accumulated in the battery;
an acquirer that acquires first data indicating a use situation of the target vehicle and second data indicating a use situation of the battery; and
a determiner that, when the first data and the second data of a certain vehicle are input, inputs the first data and the second data acquired by the acquirer into a classifier learned to output third data indicating the presence or absence of unauthorized use of the certain vehicle and determines whether the target vehicle has been unauthorized used on the basis of the third data output by the classifier into which the first data and the second data are input,
wherein the controller controls traveling of the target vehicle in a case where the determiner determines that the target vehicle has been unauthorized used.

16. An information processing method comprising causing a computer to:
communicate with a target vehicle;
acquire first data indicating a use situation of the target vehicle and second data indicating a use situation of a battery mounted in the target vehicle through a communicator;
when the first data and the second data of a certain vehicle are input, input the acquired first data and second data into a classifier learned to output third data indicating the presence or absence of unauthorized use of the certain vehicle and determine whether the target vehicle has been unauthorized used on the basis of the third data output by the classifier into which the first data and the second data are input; and
remotely control the target vehicle through the communicator in a case where it is determined that the target vehicle has been unauthorized used.

17. A computer-readable non-transitory storage medium storing a program for causing a computer to execute:
a process of communicating with a target vehicle;
a process of acquiring first data indicating a use situation of the target vehicle and second data indicating a use situation of a battery mounted in the target vehicle through a communicator;
a process of, when the first data and the second data of a certain vehicle are input, inputting the acquired first data and second data into a classifier learned to output third data indicating the presence or absence of unauthorized use of the certain vehicle and determining whether the target vehicle has been unauthorized used on the basis of the third data output by the classifier into which the first data and the second data are input; and
a process of remotely controlling the target vehicle through the communicator in a case where it is determined that the target vehicle has been unauthorized used.
